(19) United States
(12) Patent Application Publication
(10) Pub. No.: US 2025/0227411 A1
(43) Pub. Date: Jul. 10, 2025

(54) METHOD AND APPARATUS FOR ACQUIRINIG VEHICLE-MOUNTED AUDIO SIGNALS

(71) Applicant: Beijing Xiaomi Mobile Software Co., Ltd., Beijing (CN)

(72) Inventor: Shuo GAO, Beijing (CN)

(73) Assignee: Beijing Xiaomi Mobile Software Co., Ltd., Beijing (CN)

(21) Appl. No.: 18/847,080

(22) PCT Filed: Mar. 16, 2022
(86) PCT No.: PCT/CN2022/081266

§ 371 Date: Sep. 13, 2024

(51) Int. Cl. H04R 3/00; G06F 3/16; G06V 20/59; H04R 1/40

(52) U.S. Cl. CPC H04R 3/005; G06F 3/162; G06V 20/59; H04R 1/406; H04R 2201/401; H04R 2499/13

(57) ABSTRACT

A method for acquiring a vehicle-mounted audio signal includes obtaining a target sampling position of an in-vehicle audio signal, and determining, based on the target sampling position, a target microphone set from a candidate microphone collection; and obtaining, by performing enhancement processing on an audio signal acquired by the target microphone set, a target audio signal corresponding to the target sampling position.

### CROSS REFERENCE TO RELATED APPLICATION

The present application is a U.S. National Stage of International Application No. PCT/CN2022/081266, filed on Mar. 16, 2022, which is incorporated by reference herein in its entireties for all purposes.

### TECHNICAL FIELD

The present application relates to the field of vehicle technologies, and in particular to a method and apparatus for acquiring a vehicle-mounted audio signal.

### BACKGROUND

As an increasingly popular means of transportation, vehicles occupy more and more time in people's daily life and work, and become an important kind of terminal day by day. When driving a car or taking a ride in a car, people need to use cell phones, tablet computers and vehicle-mounted communication modules for remote communication with others. At this time, how to better acquire audio signals in the vehicle has become an urgent issue to be solved.

### SUMMARY

Embodiments of the present application provide a method and apparatus for acquiring a vehicle-mounted audio signal.

In a first aspect, the embodiments of the present application provide a method for acquiring a vehicle-mounted audio signal, where the method includes:
obtaining a target sampling position of an in-vehicle audio signal, and determining, based on the target sampling position, a target microphone set from a candidate microphone collection; and
obtaining, by performing enhancement processing on an audio signal acquired by the target microphone set, a target audio signal corresponding to the target sampling position.

In a second aspect, the embodiments of the present application provide a communication device. The communication device includes a processor. The processor, when invoking a computer program in the memory, performs the method according to the first aspect described above.

In a third aspect, the embodiments of the present application provide a communication device. The communication device includes a processor and a memory. The memory stores a computer program. The processor executes the computer program stored in the memory, thereby causing the communication device to perform the method according to the first aspect described above.

In a fourth aspect, the embodiments of the present application provide a communication device. The communication device includes a processor and an interface circuit. The interface circuit is configured to receive a code instruction and transmit the code instruction to the processor. The processor is configured to run the code instruction to cause the device to perform the method according to the first aspect described above.

In a fifth aspect, the embodiments of the present invention provide a computer-readable storage medium used for storing an instruction for use by the terminal device described above. When the instruction is executed, the terminal device is caused to perform the method according to the first aspect described above.

In a sixth aspect, the present application further provides a computer program product including a computer program that, when run on a computer, causes the computer to perform the method according to the first aspect described above.

In a seventh aspect, the present application provides a computer program that, when run on a computer, causes the computer to perform the method according to the first aspect described above.

### BRIEF DESCRIPTION OF THE DRAWINGS

In order to more clearly illustrate the technical solutions in the embodiments of the present application or the background art, the accompanying drawings required for use in the embodiments of the present application or the background art are described below.

FIG. 1 is a schematic distribution diagram of microphones in a vehicle provided by an embodiment of the present application;

FIG. 2 is a schematic flowchart of a method for acquiring a vehicle-mounted audio signal provided by an embodiment of the present application;

FIG. 3 is a schematic flowchart of a method for acquiring a vehicle-mounted audio signal provided by an embodiment of the present application;

FIG. 4 is a schematic distribution diagram of microphones and target sampling positions provided by an embodiment of the present application;

FIG. 5 is a schematic distribution diagram of microphones and target sampling positions provided by an embodiment of the present application;

FIG. 6 is a schematic flowchart of a method for acquiring a vehicle-mounted audio signal provided by an embodiment of the present application;

FIG. 7 is a schematic structural diagram of a communication device provided by an embodiment of the present application;

FIG. 8 is a schematic structural diagram of a communication device provided by an embodiment of the present application; and

FIG. 9 is a schematic structural diagram of a chip provided by an embodiment of the present application.

### DETAILED DESCRIPTION

Exemplary embodiments are described in detail here, examples of which are indicated in the accompanying drawings. When the following description involves the accompanying drawings, the same numerals in different accompanying drawings indicate the same or similar elements unless otherwise indicated. The embodiments described in the following exemplary embodiments do not represent all embodiments consistent with the present disclosure. On the contrary, they are only examples of devices and methods consistent with some aspects of the present disclosure as detailed in the appended claims.

The terms used in the embodiments of the present disclosure are used solely for the purpose of describing particular embodiments, and are not intended to limit the embodiments of the present disclosure. The singular forms of “a” and “the” used in the embodiments of the present disclosure and the appended claims are also intended to include the majority form, unless the context clearly indicates other meanings. It should also be understood that the term “and/or” as used in this article refers to and includes any or all possible combinations of one or more of the associated listed items.

It should be understood that although the terms first, second, and third, etc. may be used in the embodiments of the present disclosure to describe various types of information, such information should not be limited to these terms. These terms are only used for distinguishing the same type of information from one another. For example, without departing from the scope of the embodiments of the present disclosure, the first information may also be referred to as the second information, and similarly, the second information may also be referred to as the first information.

Depending on the context, the phrase “if” as used herein may be interpreted as “at the time of . . . ”, “when . . . ”, or “in response to determining”.

For the purpose of brevity and ease of understanding, the terms “greater than” or “less than”, and “higher than” or “lower than” are used in this article to characterize magnitude relationships. However, for those skilled in the art, it can be understood that the term “greater than” also covers the meaning of “greater than or equal to”, the term “less than” also covers the meaning of “less than or equal to”, the term “higher than” covers the meaning of “higher than or equal to”, and the term “lower than” covers the meaning of “lower than or equal to”.

In order to better understand the method for acquiring a vehicle-mounted audio signal disclosed in the embodiments of the present application, a communication system to which the embodiments of the present application are applicable is first described below.

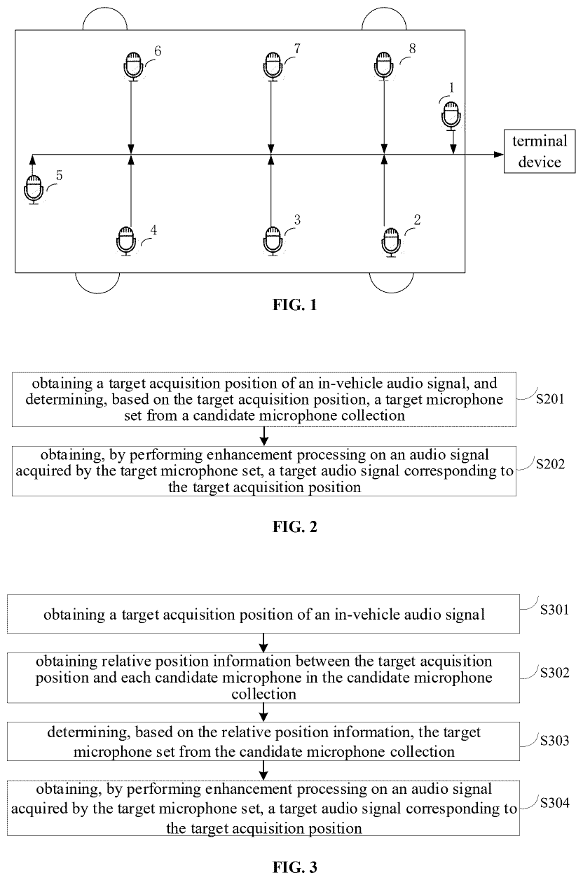

Referring to FIG. 1, FIG. 1 is a schematic distribution diagram of microphones in a vehicle provided by an embodiment of the present application. The interior of the vehicle may include, but is not limited to, a microphone and a terminal device. The terminal device may be a vehicle-mounted terminal, or a mobile terminal of a driver or passenger, such as a cell phone, a personal digital computer and a smart watch. The number and form of the microphone shown in FIG. 1 are for illustrative purposes only and do not constitute a limitation on the embodiments of the present application, and two or more microphones may be included in practical applications. The vehicle shown in FIG. 1 includes eight microphones ranging from 1 to 8 and a vehicle-mounted terminal device as an example.

It should be understood that the communication system described in the embodiments of the present application is intended to more clearly illustrate the technical solutions of the embodiments of the present application and does not constitute a limitation on the technical solutions provided by the embodiments of the present application, and those ordinary skilled in the art may know that, with the evolution of the system architecture and the emergence of new service scenarios, the technical solutions provided by the embodiments of the present application are equally applicable to similar technical problems.

The method and the apparatus for acquiring a vehicle-mounted audio signal provided by the present application are described in detail below in conjunction with the accompanying drawings.

Referring to FIG. 2, FIG. 2 is a schematic flowchart for acquiring a vehicle-mounted audio signal provided by an embodiment of the present application. The method for acquiring a vehicle-mounted audio signal is applicable to a terminal device. As shown in FIG. 2, the method may include, but is not limited to, the following steps S201 to S202.

At step S201, a target sampling position of an in-vehicle audio signal is obtained, and a target microphone set is determined, based on the target sampling position, from a candidate microphone collection.

In an embodiment of the present application, a plurality of microphones are pre-arranged in the vehicle to form the candidate microphone collection, where the candidate microphone collection includes an appropriate number of candidate microphones. Optionally, the number of the candidate microphones, i.e., the size of the candidate microphone collection, may be determined based on the size of the interior space of the vehicle.

In an embodiment of the present application, each candidate microphone is installed at a different position in the vehicle. For example, a total of 8 candidate microphones, ranging from 1 to 8, may be arranged in the front, rear, left, and right of the vehicle. Optionally, two candidate microphones may be arranged in the front, rear, left, and right of the vehicle respectively; or one candidate microphone may be arranged in the front and rear of the vehicle respectively, and three candidate microphones may be arranged in the left and right of the vehicle respectively. The specific arrangement manner may be arranged according to actual needs as long as the candidate microphones as arranged can achieve the purpose of covering the interior space of the vehicle.

In an embodiment of the present application, on the one hand, phone calls, videos, voice calls, etc. can be made through the mobile terminal, and on the other hand, voice interaction functions can be performed with the vehicle, such as playing music/videos, intelligent search, human-machine dialogue, etc. In the embodiments of the present application, audio signals of drivers and passengers can be acquired through microphones arranged in the vehicle, and one of the above functions can be achieved through the in-vehicle audio signals as acquired.

As a possible implementation, the target sampling position of the in-vehicle audio signal may be understood as a position of a terminal device used by a certain driver or passenger attempting to make an audio/video call; or the target sampling position of the in-vehicle audio signal may be a position other than the position of the terminal device, for example, the terminal device may be at the front passenger seat, and the target sampling position for acquisition may be the position corresponding to a certain passenger at the rear seat.

When making a phone call or an audio/video call, the driver or passenger may perform answering or dialing operations on the terminal device. The answering or dialing operations may be monitored. In response to the answering or dialing operations being monitored, this terminal device may be determined as the terminal device used by the driver or passenger attempting to make the audio/video call, and the position of the terminal device in the vehicle may be determined as the target sampling position. In this implementation, the terminal device is the mobile terminal of the driver or passenger, such as a mobile phone and a smart wearable device. The target sampling position may also not be the holder of the terminal device, for example, the target sampling position may be another member participating in the video call, and the position of the another member is determined as the target sampling position, where the determination of the target sampling position may be described in detail in the next implementation.

As another possible implementation, the target acquisition position of the in-vehicle audio signal may be understood as a position where a certain driver or passenger attempting to perform the voice interaction is located, and the terminal device may obtain the position of the driver or passenger as the target sampling position of the in-vehicle audio signal. In this implementation, the terminal device is a vehicle-mounted terminal.

Optionally, the driver or passenger may send an interaction instruction to the terminal device via a contact manner provided by the vehicle, thereby facilitating the terminal device to determine the position where the driver or passenger is located, i.e., the target sampling position of the in-vehicle audio signal. For example, a voice interaction button or a touch area may be provided in a riding region of the driver or passenger, and the driver or passenger may operate the button or the touch area to send the interaction instruction to the vehicle-mounted terminal. In this way, the position where the driver or passenger is located can be determined.

Optionally, the driver or passenger may send the interaction instruction to the terminal device through a non-contact manner provided by the vehicle, thereby facilitating the terminal device to determine the position where the driver or passenger is located, i.e., the target sampling position of the in-vehicle audio signal. For example, an image of a gesture or the like of the driver or passenger may be acquired by an image acquisition device, the image is sent to the terminal device, if the terminal device identifies the gesture as a specific gesture, the requirement for voice interaction is indicated, and the terminal device may determine, based on the position of the driver or passenger in the image to which the gesture in the image belongs, the position of the driver or passenger in the vehicle, thereby determining the target sampling position of the in-vehicle audio signal.

In order to improve the acquisition accuracy of the in-vehicle audio signal, an appropriate target microphone set may be selected, based on the target sampling position, from an appropriate number of microphones as arranged. Optionally, relative position information between the target sampling position and the candidate microphone may be determined, and thus the appropriate target microphone set may be selected, based on the relative position information, from the candidate microphones included in the candidate microphone collection. The target microphone set includes one or more candidate microphones as selected, and the candidate microphone as selected is referred to as the target microphone in the embodiments of the present application for the purpose of differentiation. In some embodiments, the relative position information may include at least one of the following: a distance between the target sampling position and the candidate microphone, an angle between the target sampling position and the candidate microphone, and a spatial occlusion relationship between the target sampling position and the candidate microphone.

At step S202, a target audio signal corresponding to the target sampling position is obtained by performing enhancement processing on an audio signal acquired by the target microphone set.

It should be noted that each candidate microphone in the candidate microphone collection may be connected to the terminal device through a wired or wireless manner, with the wired manner including a communication bus, and the wireless manner including the close-range communication means such as Bluetooth and infrared.

Optionally, the candidate microphone may acquire the audio signal of the driver or passenger. In order to improve the acquisition accuracy of the in-vehicle audio signal, the target microphone set determined based on the target sampling position in the present application may be formed into a microphone array, and the terminal device may obtain, by performing multi-channel enhancement processing on the audio signal acquired by the microphone array, the target audio signal corresponding to the target sampling position.

Optionally, after the target microphone set is determined, the target microphone set may be instructed to acquire the audio signal of the driver or passenger, i.e., the target microphone set is turned on, and the remaining candidate microphones are turned off. Further, the target audio signal corresponding to the target sampling position is obtained by performing multi-channel enhancement processing on the audio signal acquired by the target microphone set. Optionally, the multi-channel enhancement processing may include a classical beam forming algorithm, a multi-channel Wiener algorithm, a multi-channel subspace algorithm, a multi-channel minimum distortion algorithm, and a multi-channel statistical estimation algorithm, and the enhanced target audio signal at the target sampling position may be obtained by using a formula as shown below:

$$Y ( ω ) = Function ( {X}_{1} ( ω , θ 1 ) , {X}_{2} ( ω , θ 2 ) , {X}_{3} ( ω , θ 3 ) , … … , {X}_{N} ( ω , θ 5 ) ) ;$$

$${X}_{i} ( ω , θ i ) = Hm ( ω , θ i ) * exp ( - j ωτ m ( θ i ) ) * S ( ω ) ;$$

where Hm represents directivity of the microphone, τm represents delay associated with the position of the microphone, S(ω) represents an original audio signal; Y(ω) represents the target audio signal, Xᵢ(ω, θi) represents an audio signal of the i-th candidate microphone selected as the target microphone, and N represents the number of target microphones selected based on the target sampling position.

By implementing the embodiments of the present application, the target microphone set that is provided with a matched relative position relationship with the target sampling position can be determined, based on the target sampling position at which the audio signal needs to be acquired, from an appropriate number of microphones arranged in the vehicle, and the target microphone set as selected can be utilized to form a microphone audio signal acquisition array and obtain the target audio signal by acquiring the in-vehicle audio. In this way, interference problems existing in the mixed acquisition by a plurality of microphones can be avoided, and the purpose of accurately acquiring the audio signal at the specified target sampling position can be achieved.

Referring to FIG. 3, FIG. 3 is schematic flowchart for acquiring a vehicle-mounted audio signal provided by an embodiment of the present application. The method for acquiring a vehicle-mounted audio signal is applicable to a terminal device. As shown in FIG. 3, the method may include, but is not limited to, the following steps S301 to S304.

At step S301, a target sampling position of an in-vehicle audio signal is obtained.

The target sampling position of the in-vehicle audio signal may be understood as a position where a certain driver or passenger attempting to perform voice interaction is located, or a position of a terminal device used by a certain driver or passenger attempting to make an audio/video call; or the target sampling position of the in-vehicle audio signal may be a position other than the position of the terminal device, for example, the holder of the terminal device may be at the front passenger seat, and the target sampling position for acquisition may be the position corresponding to a certain passenger at the rear seat. The present application does not limit this.

Optionally, the driver or passenger may send an interaction instruction to the vehicle-mounted terminal via a contact manner provided by the vehicle, thereby facilitating the vehicle-mounted terminal to determine the position where the driver or passenger is located, i.e., the target sampling position of the in-vehicle audio signal. For example, a voice interaction button or a touch area may be provided in a riding region of the driver or passenger, and the driver or passenger may operate the button or the touch area to send the interaction instruction to the vehicle-mounted terminal. In this way, the position where the driver or passenger is located can be determined.

Optionally, the driver or passenger may send the interaction instruction to the vehicle-mounted terminal through a non-contact manner provided by the vehicle, thereby facilitating the vehicle-mounted terminal to determine the position where the driver or passenger is located, i.e., the target sampling position of the in-vehicle audio signal. For example, an image of a gesture or the like of the driver or passenger may be acquired by an image acquisition device, the image is sent to the vehicle-mounted terminal, if the vehicle-mounted terminal identifies the gesture as a specific gesture, the requirement for voice interaction is indicated, and the vehicle-mounted terminal may determine, based on the position of the driver or passenger in the image to which the gesture in the image belongs, the position of the driver or passenger in the vehicle, thereby determining the target sampling position of the in-vehicle audio signal.

At step S302, relative position information between the target sampling position and each candidate microphone in the candidate microphone collection is obtained.

In some embodiments, the relative position information may include at least one of the following: a distance between the target sampling position and the candidate microphone, an angle between the target sampling position and the candidate microphone, and a spatial occlusion relationship between the target sampling position and the candidate microphone.

Optionally, the vehicle-mounted terminal may obtain an in-vehicle position, i.e., an installation position of the candidate microphone, corresponding to each candidate microphone, and may determine, based on the target sampling position and the in-vehicle position of the candidate microphone, the relative position information between the target sampling position and the candidate microphone.

Optionally, an in-vehicle image is acquired, the in-vehicle image is identified, and the spatial occlusion relationship between the target sampling position and the candidate microphone is obtained. Whether a spatial occlusion relationship is present between the target object detected at the target sampling position and the candidate microphone is obtained by performing target detection on the in-vehicle image, where the spatial occlusion may include a hard occlusion or a soft occlusion, etc., for example, the spatial occlusion may include a hard occlusion such as a seatback occlusion or a soft occlusion such as a light-blocking curtain. Optionally, an in-vehicle camera may be utilized to acquire the in-vehicle image; or an infrared sensor array may be provided in the vehicle, and the in-vehicle image may be acquired based on the infrared sensor array. The present application does not limit the acquisition manner of the in-vehicle image.

At step S303, the target microphone set is selected, based on the relative position information, from the candidate microphone collection.

As a possible implementation, an appropriate target microphone set may be selected, based on the distance between the target sampling position and the candidate microphone, from the candidate microphone collection. In this implementation, the further the distance between the microphone and the target sampling position, the worse the effect of the acquired audio signal may be, i.e., the distance is negatively correlated with the acquisition effect of the audio signal. Optionally, a candidate microphone with a distance less than a set distance value may be selected as an appropriate target microphone.

As another possible implementation, an appropriate target microphone set may be selected, based on the angle between the target sampling position and the candidate microphone, from the candidate microphone collection. In this implementation, the orientation of the candidate microphone is also an aspect that affects the audio reception effect, and the quality of the audio signal acquired by the candidate microphone oriented towards the target sampling position is often higher than the quality of the audio signal acquired by the candidate microphone that is not oriented towards the target sampling position. In the embodiment of the present application, the angle between the candidate microphone and the target sampling position may reflect whether the candidate microphone is oriented towards the target sampling position. Optionally, a candidate microphone whose angle with the target sampling position is less than a set angle may be selected as an appropriate target microphone.

As yet another possible implementation, an appropriate target microphone set may be selected, based on the spatial occlusion relationship between the target sampling position and the candidate microphone, from the candidate microphone collection. In this implementation, the spatial occlusion relationship of the candidate microphone is also an aspect that affects the audio reception effect, and the quality of the audio signal acquired by the candidate microphone that does not have a spatial occlusion relationship with the target sampling position is often higher than the quality of the audio signal acquired by the candidate microphone that has a spatial occlusion relationship with the target sampling position. Optionally, a candidate microphone that does not have a spatial occlusion relationship with the target sampling position or has a small spatial occlusion with the target sampling position may be selected as an appropriate target microphone. In other implementations, the quality of the audio signal acquired by the candidate microphone that has a spatial soft occlusion relationship with the target sampling position is often higher than the quality of the audio signal acquired by the candidate microphone that has a spatial hard occlusion relationship with the target sampling position. Optionally, a candidate microphone that does not have a spatial occlusion relationship with the target sampling position or has a small spatial occlusion or a spatial soft occlusion with the target sampling position may be selected as an appropriate target microphone.

As a further possible implementation, an appropriate target microphone may be selected, based on the distance and the angle between the target sampling position and the candidate microphone, from the candidate microphone collection. That is, the target microphone as selected needs to satisfy both the distance condition and the angle condition in order to be capable of acquiring more accurate audio signals, i.e., a candidate microphone with a distance less than a set distance value and with an angle less than a set angle is selected as an appropriate target microphone.

As another possible implementation, an appropriate target microphone may be selected, based on the distance and the spatial occlusion relationship between the target sampling position and the candidate microphone, from the candidate microphone collection. That is, the target microphone as selected needs to satisfy both the distance condition and the spatial occlusion condition in order to be capable of acquiring more accurate audio signals, i.e., a candidate microphone with a distance less than a set distance value and no spatial occlusion relationship with the target sampling position, or having a small spatial occlusion or a spatial soft occlusion with the target sampling position, is selected as an appropriate target microphone.

As another possible implementation, an appropriate target microphone may be selected, based on the angle and the spatial occlusion relationship between the target sampling position and the candidate microphone, from the candidate microphone collection. That is, the target microphone as selected needs to satisfy both the angle condition and the spatial occlusion condition in order to be capable of acquiring more accurate audio signals, i.e., a candidate microphone with an angle less than a set angle and no spatial occlusion relationship with the target sampling position, or having a small spatial occlusion or a spatial hard occlusion with the target sampling position, is selected as an appropriate target microphone.

As another possible implementation, an appropriate target microphone may be selected, based on the distance, the angle and the spatial occlusion relationship between the target sampling position and the candidate microphone, from the candidate microphone collection. That is, the target microphone as selected needs to satisfy the distance condition, the angle condition and the spatial occlusion condition simultaneously in order to be capable of acquiring more accurate audio signals, i.e., a candidate microphone with a distance less than a set distance value, with an angle less than a set angle and no spatial occlusion relationship with the target sampling position, or having a small spatial occlusion or a spatial hard occlusion with the target sampling position, is selected as an appropriate target microphone.

It should be noted that the target microphone selected based on any of the above selection manners forms the target microphone set.

At step S304, a target audio signal corresponding to the target sampling position is obtained by performing enhancement processing on an audio signal acquired by the target microphone.

With respect to the specific implementation of step S304, any one of the implementations provided by the embodiments in the present application may be adopted, which will not be repeated herein.

By implementing the embodiments of the present application, the target sampling position for acquiring the in-vehicle audio signal may be determined, the target microphone set that is provided with a matched relative position relationship with the target sampling position can be determined, based on the target sampling position, from an appropriate number of microphones arranged in the vehicle, and the target microphone set as selected can be utilized to form a microphone audio signal acquisition array and obtain the target audio signal by acquiring the in-vehicle audio. In this way, interference problems existing in the mixed acquisition by a plurality of microphones can be avoided, and the purpose of accurately acquiring the audio signal at the specified target sampling position can be achieved.

The following provides an explanation of the method for acquiring an in-vehicle audio signal provided in the present application by way of example.

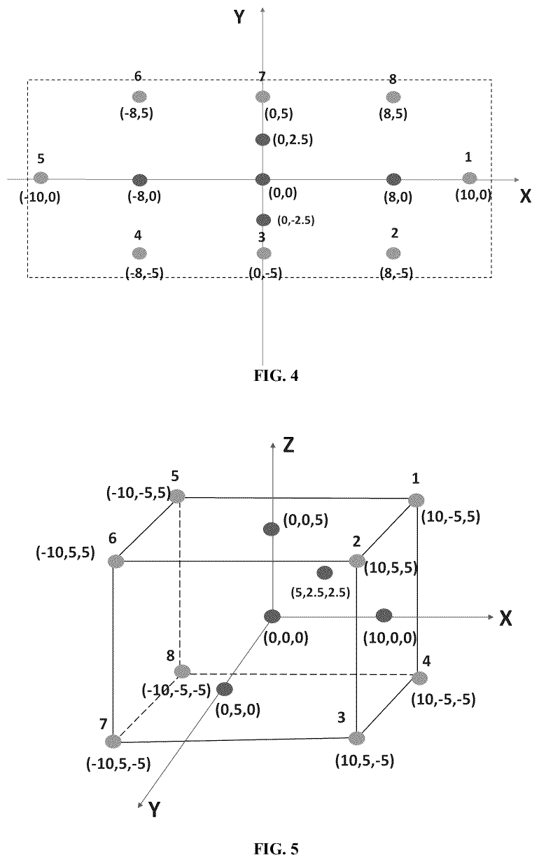

As shown in FIG. 4, a schematic arrangement diagram of candidate microphones in a two-dimensional space is shown, eight candidate microphones and a plurality of candidate positions are included in the figure, and one of the candidate positions serves as the target sampling position.

All candidate microphones are arranged on the same horizontal plane, as shown in FIG. 4, the in-vehicle positions of the eight candidate microphones are as follows:
candidate microphone #1 (10, 0), candidate microphone #2 (8, −5), candidate microphone #3 (0, −5), candidate microphone #4 (−8, −5), candidate microphone #5 (−10, 0), candidate microphone #6 (−8, 5), candidate microphone #7 (0, 5), candidate microphone #8 (8, 5).

The plurality of candidate positions are as follows: (−8, 0), (−0, 0), (8, 0), (0, 2.5), (0, −2.5). The following may take (−8, 0) as the target sampling position for illustrative explanation.

Relative position information, including at least one of the distance, the angle, and the spatial occlusion relationship, between the coordinate point (−8, 0) and the coordinate points of the eight candidate microphones is obtained.

For example, based on the distance relationship between each of the microphones and (−8, 0), a total of five candidate microphones with serial numbers 3, 4, 5, 6, and 7 are selected to form an audio acquisition array, five audio signals X₃(ω, θ3), X₄(ω, θ4), X₅(ω, θ5), X₆(ω, θ6), and X₇(ω, θ7) are acquired by the audio acquisition array, multi-channel audio enhancement is performed on the aforementioned five audio signals, and the enhanced audio signal at the target sampling position (−8, 0) is obtained as shown below:

Y(ω)=ΣWᵢXᵢ(ω,θi) i=3,4,5,6,7;

W=[w₃, w₄, w₅, w₆, w₇]T, where W represents the weight vector of the beamformer, and Xᵢ(ω, θi) represents the audio signal of the i-th candidate microphone selected as the target microphone.

As shown in FIG. 5, a schematic arrangement diagram of candidate microphones in a three-dimensional space is shown, eight candidate microphones and a plurality of candidate positions are included in the figure, and one of the candidate positions serves as the target sampling position. The in-vehicle positions of the eight candidate microphones are as follows.

All candidate microphones are not arranged on the same horizontal plane, as shown in FIG. 5, the in-vehicle positions of the eight candidate microphones are as follows:
candidate microphone #1 (10, −5, 5), candidate microphone #2 (10, 5, 5), candidate microphone #3 (10, 5, −5), candidate microphone #4 (10, −5, −5), candidate microphone #5 (−10, −5, 5), candidate microphone #6 (−10, 5, 5), candidate microphone #7 (−10, 5, −5), candidate microphone #8 (−10, −5, −5).

The plurality of candidate positions are as follows: (0, 5, 0), (0, 0, 0), (0, 0, 5), (0, 5, 0), (2.5, −2.5, 2.5). The following may take (0, 5, 0) as the target sampling position for illustrative explanation.

Relative position information, including at least one of the distance, the angle, and the spatial occlusion relationship, between the coordinate point (0, 5, 0) and the coordinate points of the eight candidate microphones is obtained.

For example, based on the distance relationship between each of the microphones and (0, 5, 0), a total of four candidate microphones with serial numbers 2, 3, 6, and 7 are selected to form an audio acquisition array, four audio signals X₂(ω, θ2), X₃(ω, θ3), X₆(ω, θ6), and X₇(ω, θ7) are acquired by the audio acquisition array, multi-channel audio enhancement is performed on the aforementioned four audio signals, and the enhanced audio signal at the target sampling position (0, 5, 0) is obtained as shown below:

Y(ω)=ΣWᵢXᵢ(ω,θi) i=2,3,6,7;

W=[w₂, w₃, w₆, w₇]T, where W represents the weight vector of the beamformer, and Xᵢ(ω, θi) represents the audio signal of the i-th candidate microphone selected as the target microphone.

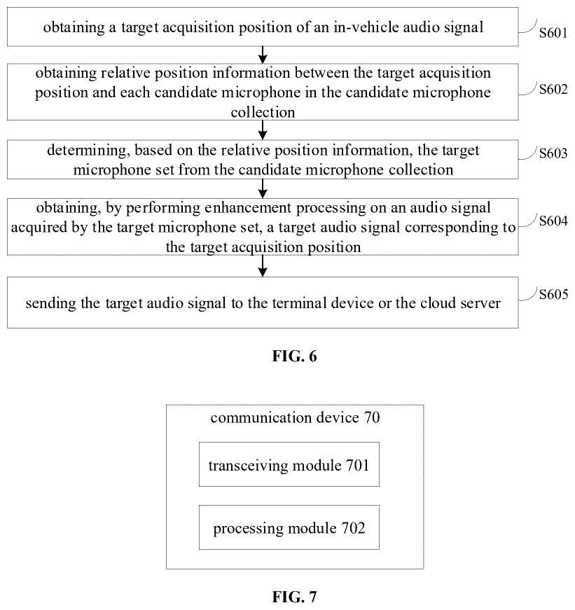

Referring to FIG. 6, FIG. 6 is a schematic flowchart for acquiring a vehicle-mounted audio signal provided by an embodiment of the present application. The method for acquiring a vehicle-mounted audio signal is applicable to a vehicle-mounted terminal. As shown in FIG. 6, the method may include, but is not limited to, the following steps S601 to S605.

At step S601, a target sampling position of an in-vehicle audio signal is obtained.

At step S602, relative position information between the target sampling position and each candidate microphone in the candidate microphone collection is obtained.

At step S603, a target microphone set is selected from the candidate microphone collection based on the relative position information.

At step S604, a target audio signal corresponding to the target sampling position is obtained by performing enhancement processing on an audio signal acquired by the target microphone set.

With respect to the specific implementations of steps S601 to S604, any one of the implementations provided by the embodiments in the present application may be adopted, which will not be repeated herein.

At step S605, the target audio signal is sent to the terminal device or the cloud server.

By implementing the embodiments of the present application, the target microphone set that is provided with a matched relative position relationship with the target sampling position can be determined, based on the target sampling position of the in-vehicle audio signal, from an appropriate number of microphones arranged in the vehicle, and the target microphone set as selected can be utilized to form a microphone audio signal acquisition array and obtain the target audio signal by acquiring the in-vehicle audio. In this way, interference problems existing in the mixed acquisition by a plurality of microphones can be avoided, and the purpose of accurately acquiring the audio signal at the specified target sampling position can be achieved.

In the above embodiments provided in the present application, the method provided in the embodiments of the present application is described from the perspective of the terminal device. In order to realize the functions in the method provided by the above embodiments of the present application, the terminal device may include a hardware structure and/or a software module, and realize the above functions in the form of a hardware structure, a software module, or a hardware structure plus a software module. A certain function of the above-described functions may be performed in the form of a hardware structure, a software module, or a hardware structure plus a software module.

Referring to FIG. 7, a schematic structural diagram of a communication device 70 provided by an embodiment of the present application is shown. The communication device 70 shown in FIG. 7 may include a transceiving module 701 and a processing module 702. The transceiving module 701 may include a sending module and/or a receiving module, where the sending module is configured to implement a sending function, the receiving module is configured to implement a receiving function, and the transceiving module 701 may implement the sending function and/or the receiving function.

The communication device 70 may be a terminal device (such as the terminal device in the aforementioned method embodiments), an apparatus in the terminal device, or a device capable of being matched for use with the terminal device.

The communication device 70 is a terminal device (such as the terminal device in the aforementioned method embodiments) and includes a processing module 702.

The processing module 702 is configured to obtain a target sampling position of an in-vehicle audio signal, determine, based on the target sampling position, a target microphone set from a candidate microphone collection, and obtain, by processing an audio signal acquired by the target microphone set, a target audio signal corresponding to the target sampling position.

Optionally, the processing module 702 is further configured to obtain relative position information between the target sampling position and each candidate microphone in the candidate microphone collection, and select, based on the relative position information, the target microphone set from the candidate microphone collection.

Optionally, the relative position information includes at least one of the following:
a distance between the target sampling position and the candidate microphone;
an angle between the target sampling position and the candidate microphone;
a spatial occlusion relationship between the target sampling position and the candidate microphone.

Optionally, the processing module 702 is further configured to: select, based on the distance between the target sampling position and the candidate microphone, the target microphone set from the candidate microphone collection; or select, based on the angle between the target sampling position and the candidate microphone, the target microphone set from the candidate microphone collection; or select, based on the spatial occlusion relationship between the target sampling position and the candidate microphone, the target microphone set from the candidate microphone collection.

Optionally, the processing module 702 is further configured to: select, based on the distance and the angle between the target sampling position and the candidate microphone, the target microphone set from the candidate microphone collection; or select, based on the distance and the spatial occlusion relationship between the target sampling position and the candidate microphone, the target microphone set from the candidate microphone collection; or select, based on the angle and the spatial occlusion relationship between the target sampling position and the candidate microphone, the target microphone set from the candidate microphone collection.

Optionally, the processing module 702 is further configured to select, based on the distance, the angle and the spatial occlusion relationship between the target sampling position and the candidate microphone, the target microphone set from the candidate microphone collection.

Optionally, the processing module 702 is further configured to obtain an in-vehicle position corresponding to the candidate microphone, and obtain a distance and/or an angle between the target sampling position and the in-vehicle position.

Optionally, the processing module 702 is further configured to acquire an in-vehicle image, identify the in-vehicle image, and obtain a spatial occlusion relationship between the target sampling position and the candidate microphone.

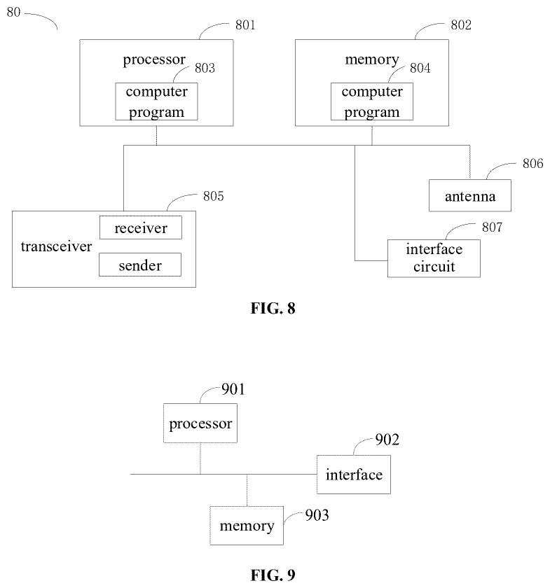

Referring to FIG. 8, FIG. 8 is a schematic structural diagram of another communication device 80 provided by an embodiment of the present application. The communication device 80 may be a network device, or a chip, a chip system or a processor, etc., that supports a terminal device (such as the terminal device in the aforementioned method embodiments) to implement the methods described above. The device may be configured to implement the method described in the aforementioned method embodiments. For details, please refer to the illustration in the above method embodiments.

The communication device 80 may include one or more processors 801. The processor 801 may be a general purpose processor or specialized processor, etc. For example, the processor 801 may be a baseband processor or central processor. The baseband processor may be configured to process communication protocols and communication data. The central processor may be configured to control the communication device (e.g., a base station, a baseband chip, a terminal device, a terminal device chip, a DU, or a CU), execute a computer program, and process data of the computer program.

Optionally, the communication device 80 may further include one or more memories 802. The one or more memories 802 may store a computer program 804. The processor 801 executes the computer program 804 to cause the communication device 80 to perform the method described in the above method embodiments. Optionally, the memory 802 may also store data. The communication device 80 and the memory 802 may be provided separately or may be integrated together.

Optionally, the communication device 80 may further include a transceiver 805 and an antenna 806. The transceiver 805 may be referred to as a transceiver unit, a transceiver device, or a transceiver circuit, etc., and is configured to implement the receiving and sending functions. The transceiver 805 may include a receiver and a sender. The receiver may be referred to as a receiving device or a receiving circuit, etc., and is configured to implement a receiving function. The sender may be referred to as a sending device or a sending circuit, etc., and is configured to implement a sending function.

Optionally, the communication device 80 may further include one or more interface circuits 807. The interface circuit 807 is configured to receive a code instruction and transmit the code instruction to the processor 801. The processor 801 runs the code instruction to cause the communication device 80 to perform the method described in the above method embodiments.

In an implementation, the processor 801 may include a transceiver configured to implement the receiving and sending functions. For example, the transceiver may be a transceiver circuit, an interface, or an interface circuit. The transceiver circuit, interface, or interface circuit configured to implement the receiving and sending functions may be separate or may be integrated together. The transceiver circuit, interface, or interface circuit described above may be configured for code/data reading and writing, or the transceiver circuit, interface, or interface circuit described above may be configured for signal transmission or delivery.

In an implementation, the processor 801 may store a computer program 803. The computer program 803 is run on the processor 801 and may cause the communication device 80 to perform the method described in the above method embodiments. The computer program 803 may be solidified in the processor 801, in which case the processor 801 may be implemented by hardware.

In an implementation, the communication device 80 may include a circuit. The circuit may implement the functions of sending, receiving or communicating in the aforementioned method embodiments. The processor and transceiver described in the present application may be implemented in an integrated circuit (IC), an analog IC, a radio frequency integrated circuit (RFIC), a mixed signal IC, an application specific integrated circuit (ASIC), a printed circuit board (PCB), and an electronic device, etc. The processor and transceiver may also be manufactured by using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication device in the description of the above embodiments may be a network device or a terminal device (such as the first terminal device in the aforementioned method embodiments), but the scope of the communication device described in the present application is not limited thereto. The structure of the communication device may not be limited by FIG. 8. The communication device may be an independent device or may be part of a large apparatus. For example, the described communication device may be:
(1) an independent integrated circuit (IC), a chip, or a chip system or subsystem;
(2) a set that has one or more ICs, optionally, the IC set may also include a storage component configured to store data and computer programs;
(3) an ASIC, such as a modem;
(4) a module that is capable of being embedded in other devices;
(5) a receiving device, a terminal device, an intelligent terminal device, a cellular phone, a wireless device, a handheld device, a mobile unit, a vehicle-mounted device, a network device, a cloud device, or an artificial intelligence device, etc.;
(6) others and so on.

For the case where the communication device may be a chip or a chip system, please refer to the schematic structural diagram of the chip shown in FIG. 9. The chip shown in FIG. 9 includes a processor 901 and an interface 902. In some embodiments, the number of processors 901 may be one or more, and the number of interfaces 902 may be more than one.

Optionally, the chip further includes a memory 903, where the memory 903 is configured to store necessary computer programs and data.

The following is for the case where the chip is configured to realize the functions of the terminal device (such as the terminal device in the aforementioned method embodiments) in the embodiments of the present application.

The processing module 901 is configured to determine, based on a target sampling position where an audio signal to be acquired is located, a target microphone set from a candidate microphone collection, and obtain, by performing enhancement processing on an audio signal acquired by the target microphone set, a target audio signal corresponding to the target sampling position.

Optionally, the processing module 901 is further configured to obtain relative position information between the target sampling position and each candidate microphone in the candidate microphone collection, and select, based on the relative position information, the target microphone set from the candidate microphone collection.

Optionally, the relative position information includes at least one of the following:
a distance between the target sampling position and the candidate microphone;
an angle between the target sampling position and the candidate microphone;
a spatial occlusion relationship between the target sampling position and the candidate microphone.

Optionally, the processing module 901 is further configured to: select, based on the distance, the target microphone set from the candidate microphone collection; or select, based on the angle, the target microphone set from the candidate microphone collection; or select, based on the spatial occlusion relationship, the target microphone set from the candidate microphone collection.

Optionally, the processing module 901 is further configured to: select, based on the distance and the angle, the target microphone set from the candidate microphone collection; or select, based on the distance and the spatial occlusion relationship, the target microphone set from the candidate microphone collection; or select, based on the angle and the spatial occlusion relationship, the target microphone set from the candidate microphone collection.

Optionally, the processing module 901 is further configured to select, based on the distance, the angle and the spatial occlusion relationship, the target microphone set from the candidate microphone collection.

Optionally, the processing module 901 is further configured to obtain an in-vehicle position corresponding to the candidate microphone, and obtain a distance and/or an angle between the target sampling position and the in-vehicle position.

Optionally, the processing module 901 is further configured to acquire an in-vehicle image, identify the in-vehicle image, and obtain a spatial occlusion relationship between the target sampling position and the candidate microphone.

Those skilled in the art can also understand that various illustrative logical blocks and steps listed in the embodiments of the present application may be implemented through electronic hardware, computer software, or a combination of the two. Whether such functions are implemented through hardware or software depends on the specific application and design requirements of the overall system. Those skilled in the art can use various methods to implement the described functions for each specific application, but such implementations should not be understood as exceeding the scope of protection of the embodiments of the present application.

The present application also provides a readable storage medium. The readable storage medium stores an instruction. The instruction, when executed by a computer, implements the function of any of the method embodiments described above.

The present application also provides a computer program product. The computer program product, when executed by a computer, implements the function of any of the method embodiments described above.

The above embodiments may be implemented in whole or in part by software, hardware, firmware, or any combination thereof. When implemented by using software, the above embodiments may be implemented in whole or in part in the form of a computer program product. The computer program product includes one or more computer programs. When the computer program is loaded and executed on a computer, a process or function is produced in whole or in part in accordance with the embodiments of the present application. The computer may be a general purpose computer, a specialized computer, a computer network, or other programmable devices. The computer program may be stored in a computer-readable storage medium or transmitted from one computer-readable storage medium to another computer-readable storage medium, e.g., the computer program may be transmitted from a web site, computer, server, or data center via a wired (e.g., coaxial cable, fiber optic, digital subscriber line (DSL)) or wireless (e.g., infrared, wireless, microwave, etc.) manner to another website site, computer, server, or data center. The computer-readable storage medium may be any usable medium to which a computer has access, or a data storage device such as a server or a data center including one or more usable media integration. The usable medium may be a magnetic medium (e.g., a floppy disk, a hard disk, a tape), an optical medium (e.g., a high-density digital video disc (DVD)), or a semiconductor medium (e.g., a solid state disk (SSD)), etc.

Those ordinary skilled in the art can understand that various numerical numbers such as “first” and “second” involved in the present application are only differentiation for the convenience of the description, and are not used for limiting the scope of the embodiments of the present application or indicate the sequential order.

The “at least one” in the present application may also be described as one or more, and the “plurality” may be two, three, four, or more, without limitation in the present application. In the embodiments of the present application, for one type of technical feature, technical features of this type are distinguished by “first”, “second”, “third”, “A”, “B”, “C”, and “D”, etc. The technical features described by “first”, “second”, “third”, “A”, “B”, “C”, and “D”, etc. are in no order of sequence or size.

The correspondence relationships shown in the tables of the present application may be configured or may be pre-defined. The values of the information in the tables are merely examples and may be configured to other values, which are not limited by the present application. In configuring the correspondence relationship between the information and the parameters, it is not necessarily required that all the correspondence relationships illustrated in the tables must be configured. For example, the correspondence relationships illustrated in certain rows of the tables in the present application may also not be configured. For another example, it is possible to make appropriate adjustments based on the above tables, such as splitting and merging. The names of the parameters shown in the headings in the above-described tables may also be other names understandable by the communication device, and the values or representations of the parameters thereof may also be other values or representations understandable by the communication device. The above tables may also be realized by using other data structures, such as arrays, queues, containers, stacks, linear tables, pointers, chain lists, trees, graphs, structure bodies, classes, heaps, hashing tables, or hash tables.

The “pre-define” in the present application may be understood as “define”, “define in advance”, “store”, “pre-store”, “pre-negotiate”, “pre-configure”, “solidified”, or “pre-fired”.

Those ordinary skilled in the art can realize that the units and algorithm steps of the examples described in combination with the disclosed embodiments in this article may be implemented in electronic hardware, or a combination of computer software and electronic hardware. Whether these functions are executed in hardware or software manners depends on the specific application and design constraints of the technical solution. Professional technicians may use different methods to implement the described functions for each specific application, but such implementations should not be considered beyond the scope of the present application.

Those skilled in the art can clearly understand that for the convenience and conciseness of the description, the specific working processes of the systems, devices and units described above may refer to the corresponding processes in the aforementioned method embodiments, which will not be repeated here.

The above is only the detailed description of the present application, but the scope of protection of the present application is not limited to this. Any technician familiar with this technical field can easily think of changes or replacements within the technical scope disclosed in the present application, and these changes or replacements should be covered within the scope of protection of the present application. Therefore, the scope of protection of the present application shall be subject to the scope of protection of the claims.

1. A method for acquiring a vehicle-mounted audio signal, performed by a terminal device, comprising:
obtaining a target sampling position of an in-vehicle audio signal, and determining, based on the target sampling position, a target microphone set from a candidate microphone collection; and
obtaining, by performing enhancement processing on an audio signal acquired by the target microphone set, a target audio signal corresponding to the target sampling position.

2. The method according to claim 1, wherein the determining the target microphone set from the candidate microphone collection comprises:
obtaining relative position information between the target sampling position and each candidate microphone in the candidate microphone collection; and
selecting, based on the relative position information, the target microphone set from the candidate microphone collection.

3. The method according to claim 2, wherein the relative position information comprises at least one of:
a distance between the target sampling position and the candidate microphone;
an angle between the target sampling position and the candidate microphone; and/or
a spatial occlusion relationship between the target sampling position and the candidate microphone.

4. The method according to claim 3, wherein the selecting, based on the relative position information, the target microphone set from the candidate microphone collection comprises:
selecting, based on the distance, the target microphone set from the candidate microphone collection;
selecting, based on the angle, the target microphone set from the candidate microphone collection; or
selecting, based on the spatial occlusion relationship, the target microphone set from the candidate microphone collection.

5. The method according to claim 3, wherein the selecting, based on the relative position information, the target microphone set from the candidate microphone collection comprises:
selecting, based on the distance and the angle, the target microphone set from the candidate microphone collection; or
selecting, based on the distance and the spatial occlusion relationship, the target microphone set from the candidate microphone collection; or
selecting, based on the angle and the spatial occlusion relationship, the target microphone set from the candidate microphone collection.

6. The method according to claim 3, wherein the selecting, based on the relative position information, the target microphone set from the candidate microphone collection comprises:
selecting, based on the distance, the angle and the spatial occlusion relationship, the target microphone set from the candidate microphone collection.

7. The method according to claim 2, wherein the obtaining the relative position information between the target sampling position and each candidate microphone in the candidate microphone collection comprises:
obtaining an in-vehicle position corresponding to the candidate microphone; and
obtaining at least one of a distance or an angle between the target sampling position and the in-vehicle position.

8. The method according to claim 2, wherein the obtaining the relative position information between the target sampling position and each candidate microphone in the candidate microphone collection comprises:
acquiring an in-vehicle image, identifying the in-vehicle image, and obtaining a spatial occlusion relationship between the target sampling position and the candidate microphone.

9. (canceled)

10. An electronic device, comprising:
a processor; and
a memory, wherein
the memory stores a computer program, and the processor, through executing the computer program stored in the memory, is configured to:
obtain a target sampling position of an in-vehicle audio signal, and determine, based on the target sampling position, a target microphone set from a candidate microphone collection; and
obtain, by performing enhancement processing on an audio signal acquired by the target microphone set, a target audio signal corresponding to the target sampling position.

11. An electronic apparatus, comprising:
a processor; and
an interface circuit; wherein
the interface circuit is configured to receive a code instruction and transmit the code instruction to the processor; and
the processor is configured to run the code instruction to perform the method according to claim 1.

12. A non-transitory computer-readable storage medium, storing an instruction that, when executed by an electronic device, causes the electronic device to perform a method for acquiring a vehicle-mounted audio signal, wherein the method comprises:
obtaining a target sampling position of an in-vehicle audio signal, and determining, based on the target sampling position, a target microphone set from a candidate microphone collection; and
obtaining, by performing enhancement processing on an audio signal acquired by the target microphone set, a target audio signal corresponding to the target sampling position.

13. The electronic device according to claim 10, wherein the processor is specifically configured to:
obtain relative position information between the target sampling position and each candidate microphone in the candidate microphone collection; and
select, based on the relative position information, the target microphone set from the candidate microphone collection.

14. The electronic device according to claim 13, wherein the relative position information comprises at least one of:
a distance between the target sampling position and the candidate microphone;
an angle between the target sampling position and the candidate microphone; or
a spatial occlusion relationship between the target sampling position and the candidate microphone.

15. The electronic device according to claim 14, wherein the processor is specifically configured to:
select, based on the distance, the target microphone set from the candidate microphone collection;
select, based on the angle, the target microphone set from the candidate microphone collection; or
select, based on the spatial occlusion relationship, the target microphone set from the candidate microphone collection.

16. The electronic device according to claim 14, wherein the processor is specifically configured to:
select, based on the distance and the angle, the target microphone set from the candidate microphone collection;
select, based on the distance and the spatial occlusion relationship, the target microphone set from the candidate microphone collection; or
select, based on the angle and the spatial occlusion relationship, the target microphone set from the candidate microphone collection.

17. The electronic device according to claim 14, wherein the processor is specifically configured to:
select, based on the distance, the angle and the spatial occlusion relationship, the target microphone set from the candidate microphone collection.

18. The electronic device according to claim 13, wherein the processor is specifically configured to:
obtain an in-vehicle position corresponding to the candidate microphone; and
obtain at least one of a distance or an angle between the target sampling position and the in-vehicle position.

19. The electronic device according to claim 13, wherein the processor is specifically configured to:
acquire an in-vehicle image, identify the in-vehicle image, and obtain a spatial occlusion relationship between the target sampling position and the candidate microphone.

20. The non-transitory computer-readable storage medium according to claim 12, wherein the determining the target microphone set from the candidate microphone collection comprises:
obtaining relative position information between the target sampling position and each candidate microphone in the candidate microphone collection; and
selecting, based on the relative position information, the target microphone set from the candidate microphone collection.

21. The non-transitory computer-readable storage medium according to claim 20, wherein the relative position information comprises at least one of:
a distance between the target sampling position and the candidate microphone;
an angle between the target sampling position and the candidate microphone; or
a spatial occlusion relationship between the target sampling position and the candidate microphone.
